(19) United States
(12) Patent Application Publication
(10) Pub. No.: US 2013/0172499 A1
(43) Pub. Date: Jul. 4, 2013

(54) PROCESS FOR THE PREPARATION OF OLEFIN POLYMERS IN THE PRESENCE OF CHROMIUM CATALYSTS

(71) Applicants: Michael W. Lynch, West Chester, OH (US); Kenneth J. Klug, Houston, TX (US)

(72) Inventors: Michael W. Lynch, West Chester, OH (US); Kenneth J. Klug, Houston, TX (US)

(21) Appl. No.: 13/725,003

(22) Filed: Dec. 21, 2012

Related U.S. Application Data
(60) Provisional application No. 61/581,814, filed on Dec. 30, 2011.

(51) Int. Cl. C08F 4/22

(52) U.S. Cl. CPC C08F 4/22
USPC 526/130

(57) ABSTRACT

A process for the polymerization of olefin carried out in the presence of a Cr-oxide supported catalyst and a cocatalyst the improvement comprising polymerizing in the presence of an effective amount of hydrogen thereby obtaining an increased catalyst activity.

### CROSS REFERENCE TO RELATED APPLICATIONS

This application claims benefit of priority of U.S. Provisional Application No. 61/581,814 filed on Dec. 30, 2011, which is incorporated herein by reference in its entirety.

### FIELD OF THE INVENTION

The invention relates to an improved process for preparing an ethylene homo- or copolymer in the presence of a supported chromium catalyst, said improvement comprising using conditions such that the polymerization activity of the catalyst is greatly increased.

### BACKGROUND OF THE INVENTION

Homopolymers and copolymers comprising ethylene and higher alpha-olefins such as 1-butene, 1-pentene, 1-hexene or 1-octene, may be prepared in the presence of supported chromium compounds, known as Phillips catalysts. In their simplified version, the Phillips catalysts are generally obtained by: (1) impregnating a carrier substance with a chromium-containing solution, (2) evaporating the solvent and (3) activating the solid under oxidizing conditions, for example in an oxygen-containing atmosphere, at 400 to 1000° C. to generate chromium (VI) species.

Various methods exist for improving the activity of the chromium catalysts. In general, these methods relate to modifying particular aspects of the catalyst preparation process that impact the catalyst activity. As an example, varying the activation temperature and the amount of chromium in the catalyst has been found to have an effect on the specific catalyst activity.

However, changing the catalyst recipe generally increases the activity of the particular catalyst and only produces a product with characteristics that are specific to that catalyst.

Therefore there is a need to increase the catalyst activity without modifying the catalyst recipe, i.e. to be applied directly in polymerization.

European Publication No. 307907 describes a polymerization process comprising contacting an ethylene feed with a catalyst comprising chromium on a high titania, silica-titania cogel support. The catalyst is first activated in an oxygen-containing ambient atmosphere, reduced with carbon monoxide, and then pre-contacted with a co-catalyst. During polymerization, hydrogen is introduced into the reactor in an amount sufficient to produce a polymer having a density in the range of about 0.915 to about 0.965 g/cc. According to this publication, by incorporating hydrogen into the process it is possible to generate ethylene polymers having short branches like those produced in ethylene copolymerization with other alpha olefin comonomers like, butene, hexene-1 and octene-1. The said polymers would have a lower density than what is typical for linear ethylene homopolymers and have an improved impact resistance.

International Patent Publication WO 02/42341 describes an ethylene polymerization process carried out in gas-phase in the presence of a chromium oxide catalyst and of an alkyl boron compound with the purpose of influencing the polymer properties (i.e., molecular weight and density). This publication also mentions, without giving any further explanation, that a synergistic effect between boron alkyl compound and hydrogen could be obtained. Use of hydrogen in polymerization reactor is only described for comparative examples 2 and 3.

### SUMMARY OF THE INVENTION

In general, the present invention provides a process for the polymerization of olefin carried out in the presence of a Cr-oxide supported catalyst, a co-catalyst, and an effective amount of hydrogen thereby obtaining an increased catalyst activity.

More specifically, the present invention provides a process for polymerizing an olefin comprising the steps of
(i) forming an activated silica supported chromium catalyst further comprising the steps of:
   (a) preparing a homogeneous solution comprising an organic or inorganic chromium compound in a protic or aprotic polar solvent,
   (b) bringing the resulting solution from (a) into contact with the silica material to form a solid,
   (c) removing the solvent from the resulting solid formed in (b) thereby forming a chromium catalyst precursor; and
   (d) calcination of the chromium catalyst precursor at a temperature between 350 to 1050° C., under oxidative conditions to form the activated silica supported chromium catalyst
(ii) polymerizing an olefin in the presence of
   (a) the silica supported chromium catalyst
   (b) a co-catalyst, and
   (c) hydrogen wherein hydrogen is present in a concentration of 0.01 to 5 mole % based upon total content of polymerization contents.

In some embodiments, the cocatalyst is selected from organometallic compound of a metal from groups I to III of the Periodic Classification of the Elements.

In general embodiments, the co-catalyst is selected from the group consisting of organoaluminum compounds, lithium organo compounds, alkyl boron compounds and mixtures thereof.

In certain embodiments, the polymerization is carried out in gas phase or slurry phase.

In particular embodiments, the polymerization is carried out in the presence of hydrogen used in an amount of from 0.03 to 2 mole %. In specific embodiments, the amount of hydrogen ranges from 0.07 to 1.5 mole %.

In some embodiments, the supported chromium catalyst precursor is supported on a refractory oxide support.

In certain embodiments, the supported chromium catalyst further comprises secondary dopants or mixtures of dopants. In particular embodiments, the dopants are organic or inorganic compounds of atoms selected from Mg, Ca, Sr, B, Al, Si, P, Bi, Sc, Ti, V, Mn, Fe, Co, Ni, Cu, Zn, Zr, Nb, Mo, Ru, Rh, Pd, Hf, Ta, W, B, and F. In specific embodiments, the dopant is selected from compounds of the general formula M(OR)nX4-n, where M is titanium or zirconium and R is a hydrocarbon compound which has from 1 to 20 carbon atoms, and n is an integer from 0 to 4.

### BRIEF DESCRIPTION OF THE DRAWINGS

For a more complete understanding of the present invention, reference is now made to the following descriptions taken in conjunction with the accompanying drawing.

FIG. 1 shows a plot of ethylene flow (g/Hr) versus time (minutes) during the polymerization of ethylene and hexane at 100° C. in the presence butyl lithium (BuLi) using a Cr/silica catalyst that was activated at 800° C.

FIG. 2 shows a plot of ethylene flow (g/Hr) versus time (minutes) during the polymerization of ethylene and hexane at 100° C. in the presence of butyl lithium (BuLi) and TEB (co-catalyst) using a Cr/silica catalyst that was activated at 800° C.

### DESCRIPTION OF THE PREFERRED EMBODIMENTS

Examples of chromium oxide catalysts according to the present invention are typically those comprising a refractory oxide support which is activated by a heat treatment. In general embodiments, the heat treatment is carried out at a temperature of at least 250° C. The first stage of the process to produce this catalyst begins with a chromium compound, such as a chromium oxide, generally of formula CrO₃, or a chromium compound which can be converted by calcination into chromium oxide, such as, for example, a chromium nitrate or sulphate, an ammonium chromate, a chromium carbonate, acetate or acetylacetonate, or a tert-butyl chromate. The chromium compound is combined with a granular support based on refractory oxide, such as, for example, silica, alumina, zirconium oxide, titanium oxide or a mixture of these oxides or aluminium or boron phosphates or mixtures in any proportion of these phosphates with the above mentioned oxides. In some embodiments, the supported chromium oxide catalyst of the present invention is combined with a secondary dopants or mixtures of dopants which include all organic or inorganic compounds of elements selected from among Mg, Ca, Sr, B, Al, Si, P, Bi, Sc, Ti, V, Mn, Fe, Co, Ni, Cu, Zn, Zr, Nb, Mo, Ru, Rh, Pd, Hf, Ta, W, B, and F which are readily soluble in the polar solvent chosen. In preferred embodiments, the secondary dopant includes compounds of elements selected from among Zr, Al and Ti, B, and F. The secondary dopants include compounds that form a chelate of the elements. Particular preference is given to compounds of the general formula M(OR)ₙX₄₋ₙ, where M is titanium or zirconium and R is a hydrocarbon compound which has from 1 to 20 carbon atoms and is preferably selected from the group consisting of substituted or unsubstituted alkyl groups such as methyl, ethyl, n-propyl, n-butyl, tert-butyl, n-pentyl, n-hexyl, n-heptyl, n-octyl, vinyl, allyl, benzyl, phenyl; X is a halogen atom, a carboalkoxy group, a carboxyl group, an acyl alkenate or a hydrocarbon compound having from 1 to 20 carbon atoms and n is an integer from 0 to 4. Preferred zirconium compounds are selected from the group consisting of ZrO₄, ZrO(NO₃)₂, ZrOSO₄, ZrOCl₂, Zr(OR)₄, zirconium acetate, zirconium ethylhexanoate, zirconium pentane dionate and zirconium acetylacetonate. Particular preference is given to zirconium (IV) propoxide. Preferred titanium compounds are selected from those having the formula Ti(OR)₄ where R can be a C₁₋₁₀ straight chain, branched or cyclic alkyl group.

The catalyst preferably contains from 0.05 to 5%, more preferably from 0.1 to 2%, by weight of chromium. The catalyst can contain by weight, in addition to the chromium, from 0.1 to 10%, preferably from 0.5 to 5% of titanium in the form of titanium oxide and/or from 0.05 to 5%, preferably from 0.25 to 5% of aluminium, in particular in the form of aluminium oxide and preferably from 0.5 to 10% more preferably from 1 to 5% of zirconium. The present invention is particularly suitable when aluminium and/or titanium and/or zirconium modified chromium oxide catalysts are used. It is preferably supported on silica.

Typically, the chromium catalysts are prepared by the following steps:

(a) preparing a homogeneous solution comprising an organic or inorganic chromium compound in a protic or aprotic polar solvent,
(b) bringing the solution from a) into contact with the silica material,
(c) removing the solvent from the solid and
(d) calcination of the solid at temperatures of from 350 to 1050° C., preferably from 400 to 950° C. under oxidative conditions.

In step a) preference is given to using chromium compounds having a valence of less than six, particularly preferably Cr (III) compounds. Compounds of this type include, for example, chromium hydroxide and soluble salts of trivalent chromium with an organic or inorganic acid, e.g. acetates, oxalates, sulfates or nitrates. Particular preference is given to salts of acids which during activation are converted essentially into chromium (VI) without leaving a residue, e.g. chromium (III) nitrate nonahydrate. Furthermore, chelate compounds of chromium, e.g. chromium derivatives of β-diketones, β-ketoaldehydes or β-dialdehydes, and/or complexes of chromium, e.g. chromium(III) acetylacetonate or chromium hexacarbonyl, or organometallic compounds of chromium, e.g. bis(cyclopentadienyl)chromium(II), organic chromic(VI) esters or bis(arene)chromium(0), can likewise be used.

Suitable solvents include all protic or aprotic polar solvents, with preference being given to organic solvents. Particular preference is given to organic protic solvents. The solvent is preferably a saturated, unsaturated or aromatic organic liquid.

Protic solvents are, for example, alcohols R¹—OH, primary amines NH₂R¹₁, secondary amines NHR¹₂, quaternary ammonium cations N⁺HR¹₃, C₁-C₅-carboxylic acids and inorganic aqueous acids such as dilute hydrochloric acid or sulfuric acid, water, aqueous ammonia or mixtures thereof, where R¹ is independently selected from C₁-C₂₀-alkyl, alkenyl, C₆-C₂₀-aryl, alkylaryl having from 1 to 10 carbon atoms in the alkyl part and 6-20 carbon atoms in the aryl part.

Aprotic solvents are, for example, ketones, ethers, esters and nitriles, without being restricted thereto.

After preparation of the homogeneous solution, the active components are applied to the silica support material.

Preferred support materials are silica xerogels, which may be prepared, for example, as described in DE-A-2,540,279, the contents of which are incorporated herein by reference in its entirety.

Further advantageous supports are those described in WO 97/48743, the contents of which are incorporated herein by reference in its entirety. These are fragile, agglomerated catalyst support particles which have a specific surface area of from 1 m²/g to 1000 m²/g and are prepared by spray drying primary particles having a mean particle size of from 3 μm to 10 μm. The primary particles for producing the agglomerated catalyst support particles are derived from a slurry of dry-milled and/or wet-milled inorganic oxide particles in water. Silica supports are also commercially available. Grace Chemical for example commercializes silica supports with the commercial name XPO.

The homogeneous solution comprising the chromium compound and/or the secondary dopant is added to the support. In some embodiments, the support can also be suspended in a solution comprising the chromium compound and/or the secondary dopant in which the liquid constituents of the reaction mixture can be evaporated with continuous homogeneous, mixing.

The application of a chromium compound is preferably carried out from a from 0.05% strength by weight to 15% strength by weight solution of a chromium compound which is converted under the activation conditions into chromium(VI) oxide in a C₁-C₄-alcohol, with the respective solvent preferably containing not more than 20% by weight of water. Loading of the support without use of solvents, for example by mechanical mixing, is also possible.

The chromium compound is present in a concentration of usually from 0.05 to 20 wt.-%, preferably from 0.1 to 15 wt.-% and particularly preferably from 0.5 to 10 wt.-%, based on the polar solvent.

The weight ratio of the chromium compounds and secondary dopant to the support during loading is in each case preferably in the range from 0.001:1 to 200:1, more preferably in the range from 0.005:1 to 100:1. The amount of solution used during doping in step (b) is preferably smaller than the pore volume of the support.

Reaction steps a) and b) can be carried out independently of one another at temperatures of from 0 to 150° C. To improve the solvent capability, a slightly elevated temperature up to 60° C. may also be preferred. In some embodiments, optimal isolation of one of the reaction products formed in the solution may be performed.

After the chromium compound and the secondary dopant are placed on the solid support, the solvent is removed from the resulting catalyst precursor at a temperature between 20 to 150° C. and at a pressure between 10 mbar to 1 mbar. This step may be necessary to facilitate the subsequent calcination step (optional step c). Also, if it is appropriate the calcination step may be carried out under reduced pressure and/or at elevated temperature.

The catalyst precursor obtained from reaction step b) or c) can immediately be subjected to step d) or else can be calcined beforehand in a further intermediate step in a water-free inert gas atmosphere at temperatures above 300° C. The calcination is preferably carried out under inert gas at temperatures of from 300 to 800° C. in a fluidized bed over a time period of from 10 to 1000 minutes.

The final calcination of the catalyst precursor (step d) is carried out at temperatures of from 350 to 1050° C., preferably from 400 to 950° C. The final calcination step involves the thermal activation of the catalyst in an oxidizing atmosphere (i.e., completely converting the chromium compound into the hexavalent state). The choice of calcination temperature is determined by the properties of the polymer to be prepared and the activity of the catalyst. At the upper limit of the temperature range sintering of the support will occur and the lower limit of the temperature range the activity of the catalyst becomes too low. The final calcination step is preferably carried out at least 20 to 100° C. below the sintering temperature. The calcination preferably takes place in an oxygen-containing atmosphere. The chromium catalyst precursor obtained from step b) or c) is preferably activated directly in the fluidized bed reactor by replacing an inert gas atmosphere with an oxygen-containing gas atmosphere and by increasing the temperature to the activation temperature. It is preferably heated to the calcination temperature in a water-free gas stream comprising more than 10% by volume of oxygen over a time period of from 10 to 1000 minutes, in particular from 150 to 750 minutes, and then cooled to room temperature. This procedure provides an active catalyst ready for polymerization.

The activation may be carried out in a fluidized bed and/or in a stationary bed. In a preferred embodiment, the thermal activation step is carried in a fluidized-bed reactor.

Although it is known in the art that the activated supported catalyst may be cooled and subjected to at least a partial reduction of the hexavalent chromium to a lower valence state prior to combining with the cocatalyst, it has been found preferable not to carry out such a reduction stage. As a consequence, substantially all the chromium atoms in the catalyst are in the hexavalent stage. The chromium oxide catalysts used in the present invention may be used together with an organometallic compound of a metal from groups I to III of the Periodic Classification of the Elements, such as, for example, an organoaluminum compounds, Lithium compounds and alkyl boron compounds.

Organo aluminum compounds may also act as a scavenger which purifies the reaction gas mixture.

Among boron alkyl compound preferred are those of formula BR₃ or BR₂(OR), preferably BR₃, where each R (which can be the same or different, preferably the same) represents an alkyl group with from 1 to 10 carbon atoms, preferably 2 to 4 carbon atoms. Triethylboron is preferably used. In accordance with the present invention, the boron alkyl compound is preferably added in an amount corresponding to boron to chromium atomic ratio between 0.01 and 100, preferably between 0.5 and 50, most preferably between 1 and 10.

Preferred alkyl lithium compounds are hydrocarbyl lithium compounds, particularly those having an alkyl group comprising from about 1 to about 12 carbon atoms, preferably, from about 2 to about 8 carbon atoms. Most preferably, the alkyl lithium compounds will have from 2 to 5 carbon atoms per alkyl group for best reactivity and desired decrease of the resultant polymer melt index. Exemplary lithium compounds include, but are not limited to, n-butyl lithium, propyl lithium, and ethyl lithium. Aryl lithium compounds, such as phenyl lithium, are also suitable. The lithium cocatalyst can be used in an amount so as to give the atom ratio of lithium metal to active chromium catalyst component within a range of about 0.5:1 to about 10:1, preferably from about 2:1 to about 5:1.

In some embodiments, the supported catalysts may be used for the polymerization and/or copolymerization of ethylene alone or together with other olefins. In certain embodiments, the supported catalyst may be used in a process for polymerizing ethylene and C₃-C₂₀-olefins as co-monomers in the presence of the supported polymerization catalyst.

In some embodiments, the catalyst systems described herein may be used in catalytic polymerization processes such as a suspension polymerization process, a gas-phase polymerization process or any process that may take place in a suspension polymerization reactor.

In some embodiments, antistatic agents may be added to the polymerization reaction mixture. Preferred antistatic agents include ZnO and/or MgO. In some embodiments, the antistatic agents are added in amounts ranging from 0.1% by weight to 5% by weight, based on the total amount of the catalyst mixture. The water content of ZnO or MgO is preferably less than 0.5% by weight, more preferably less than 0.3% by weight, based on the respective total mass of the supported catalyst. An example of a commercial product which can be used is Statsafe 3000, obtainable from Dupont. Antistatic which can be used are, for example, known from European Publication No. 229368, U.S. Pat. No. 5,026,795 and U.S. Pat. No. 4,182,810, the contents of which are incorporated herein by reference in their entirety.

As already explained, it has been discovered that by using an effective amount of hydrogen in the gas polymerization mixture increases the activity of the catalyst. Also small amounts of hydrogen have been proven to be effective and particularly those in the range of 0.01 to 5 mole % more preferably 0.03 to 2 mole % based on the total amount of the polymerization reactor contents. Before now, it was thought that the amount of hydrogen would only induce a variation in the properties of the resulting polymer; however, it was found that the catalyst activity could be increased by modifying the hydrogen concentration.

The melt flow rate (MFR) was measured according to ASTM D 1238. The term “ASTM D 1238” as used herein refers to the standard test method for determining melt flow rates of thermoplastics by extrusion plastometer. In general, this test method covers the determination of the rate of extrusion of molten thermoplastic resins using an extrusion plastometer. After a specified preheating time, resin is extruded through a die with a specified length and orifice diameter under prescribed conditions of temperature, load, and piston position in the barrel. This test method was approved on Feb. 1, 2012 and published March 2012, the contents of which are incorporated herein by reference in its entirety. For the referenced ASTM standards, visit the ASTM website, www.astm.org, or contact ASTM Customer Service at service@astm.org.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

The catalysts were obtained from commercial vendors. Catalysts were activated in a fluidized bed, in a quartz tube, activation temperatures as stated in the catalyst summary table, Table 2. The N₂ to air switch was at 540° C. and the air to N₂ switch at 340° C. Polymerization runs were conducted in a 2 liter reactor with 900 mls isobutane diluent, 5 mls 1-hexene comonomer, and 0.2 mls of a 1.6M BuLi cocatalyst. Optionally hydrogen was added to the reactor as a pressure drop from a 90 ml vessel. Aspen calculations were used to determine ethylene concentration, and hydrogen concentration in the polymerization liquid. The following table, Table 1, correlates the amount of hydrogen added to the reactor to its concentration in the liquid phase.

TABLE 1
CORRELTATION OF AMOUNT OF HYDROGEN ADDED
TO THE REACTOR AND THE MOLE % OF HYDROGEN
IN THE LIQUID PHASE.

| | ASPEN mole % |
|---|---|
| H₂ (psi) | H₂ in liquid |
| 50 | 0.03 |
| 170 | 0.10 |
| 340 | 0.20 |
| 500 | 0.29 |
| 1000 | 0.59 |
| 1500 | 0.88 |
| 1700 | 1.00 |
| 2000 | 1.18 |

Triethyl boron, TEB, was added as a co-catalyst to the runs. The experimental details are shown in Table 2 and Table 3. The triethyl boron concentration was 0.02M for each example.

TABLE 2
CATALYST

| | Pore | Surface | | | | | Activation |
|---|---|---|---|---|---|---|---|
| Catalyst | volume | Area | Cr | Al | Ti | Zr | Temperature |
| ID | (ml/g) | (m²/g) | (equivalents) | (equivalents) | (equivalents) | (equivalents) | (° C.) |
| A | 2.3 | 500 | 1 | 0 | 2.5 | 0 | 800 |
| B | 2.3 | 500 | 1 | 0 | 2.5 | 0 | 800 |
| C | 2.3 | 500 | 1 | 0 | 2.5 | 0 | 600 |
| D | 2.3 | 500 | 1 | 0 | 2.5 | 0 | 540 |
| E | 2.2 | 345 | 1 | 2.5 | 0 | 0 | 600 |
| F | — | — | 1 | 0 | 0 | 2.2 | 600 |
| G | — | — | 1 | 0 | 0 | 2.2 | 800 |

TABLE 3
POLYMERIZATION DATA

| | | TEB | RT | RP | C6⁺ | H₂ | time | Activity [symbol] | MI | HLMI | |
|---|---|---|---|---|---|---|---|---|---|---|---|
| Ex. | Cat. | (mls) | (° C.) | (psig) | (mls) | dp(psi) | (min) | gPE/g cat-hr | (2.16 kg) | (21.6 kg) | MIR |
| 1 | A | 0.05 | 100 | 420 | 5 | 0 | 95 | 515 | 0.96 | 103.5 | 108 |
| 2 | A | 0.05 | 100 | 430 | 5 | 170 | 97 | 1839 | 0.92 | 69.2 | 75 |
| 3 | B | 0.00 | 100 | 430 | 5 | 0 | 120 | 1676 | 0.18 | 21.7 | 118 |
| 4 | B | 0.00 | 100 | 430 | 5 | 170 | 60 | 4248 | 0.90 | 63.7 | 71 |
| 5 | B | 0.00 | 100 | 430 | 5 | 85 | 72 | 3450 | 0.94 | 62.7 | 67 |
| 6 | C | 0 | 103 | 441 | 5 | 0 | 72 | 1638 | 0.19 | 22.8 | 119 |
| 7 | C | 0 | 103 | 459 | 5 | 340 | 98 | 2544 | 0.29 | 20.4 | 71 |
| 8 | D | 0.20 | 95 | 400 | 10 | 170 | 60 | 3154 | 0.10 | 14.8 | 156 |
| 9 | D | 0.20 | 100 | 423 | 10 | 0 | 60 | 2073 | 0.08 | 19.6 | 242 |
| 10 | D | 0.20 | 97 | 409 | 10 | 50 | 60 | 2631 | 0.07 | 14.5 | 217 |
| 11 | E | 0.05 | 100 | 439 | 5 | 340 | 60 | 3479 | 0.36 | 37.8 | 98 |
| 12 | E | 0.05 | 100 | 425 | 5 | 50 | 60 | 2373 | 0.23 | 30.3 | 131 |
| 13 | E | 0.05 | 100 | 421 | 5 | 0 | 60 | 1509 | 0.23 | 33.0 | 144 |
| 14 | F | 0.50 | 100 | 423 | 10 | 0 | 60 | 1929 | 0.03 | 8.1 | 253 |
| 15 | F | 0.5 | 100 | 430 | 10 | 170 | 60 | 2772 | 0.09 | 16.8 | 181 |
| 16 | G | 0 | 98 | 485 | 5 | 0 | 60 | 2798 | | 1.7 | |
| 17 | G | 0 | 98 | 494 | 5 | 170 | 60 | 5231 | | 4.5 | |
| 18 | G | 0 | 98 | 490 | 5 | 50 | 60 | 3327 | | 3.,4 | |
| 19 | G | 0 | 98 | 494 | 5 | 170 | 60 | 5009 | | 5.1 | |
| 20 | G | 0 | 98 | 503 | 5 | 340 | 60 | 4410 | | 6.7 | |
| 21 | B | 0.2 | 100 | 430 | 5 | 340 | 64 | 3895 | 0.69 | 49.6 | 72 |
| 22 | B | 0.2 | 100 | 430 | 5 | 0 | 60 | 1455 | 0.33 | 40.9 | 126 |
| 23 | B | 0.2 | 100 | 430 | 5 | 170 | 85 | 2536 | 0.5 | 47.8 | 96 |
| 24 | B | 0.2 | 100 | 430 | 5 | 25 | 80 | 1652 | 0.43 | 47.4 | 111 |
| 25 | B | 0.2 | 100 | 430 | 5 | 50 | 80 | 1840 | 0.47 | 47.8 | 102 |

[symbol]

indicates data missing or illegible when filed

The comparison of Example 1 and 2 shows that the polymerization of an olefin with catalyst A and TEB as co-catalyst in the presence of H₂ leads to higher catalyst mileage.

The comparison of Examples 3-5 show that with catalyst B, the polymerization in the presence of H₂ leads to higher catalyst mileage without using TEB co-catalyst.

The comparison of Examples 6 and 7 show that with catalyst C polymerization with H₂ leads to higher catalyst mileage without using TEB cocatalyst. The base catalyst for Catalysts A through D is the same with the difference being the temperature used to activate the catalyst. This shows the invention is operable with catalyst activated at different activation temperatures.

Examples 8-10 show that with catalyst D polymerization with H₂ leads to higher catalyst mileage while using TEB cocatalyst. The base catalyst for Catalysts A through D is the same differing by activation temperature. This shows the invention is operable with catalyst activated at different activation temperatures.

Examples 11-13 show that with catalyst E polymerization with H₂ leads to higher catalyst mileage while using TEB cocatalyst. Catalyst E is an Al modified Cr catalyst while catalysts A-D were Ti modified Cr catalysts. This example demonstrates the invention is operative for Al modified Cr catalysts as well.

Examples 14-16 show that with catalyst F polymerization with H₂ leads to higher catalyst mileage while using TEB cocatalyst. Catalyst F is a Zr modified Cr catalyst. This example demonstrates the invention is operative for Zr modified Cr catalysts as well.

Examples 17-21 show that with catalyst G polymerization with H₂ leads to higher catalyst mileage without using TEB cocatalyst. Catalyst G is a Zr modified Cr catalyst activated at a different temperature than catalyst F. This example demonstrates the invention is operative for Zr modified Cr catalysts activated at different activation temperatures as well.

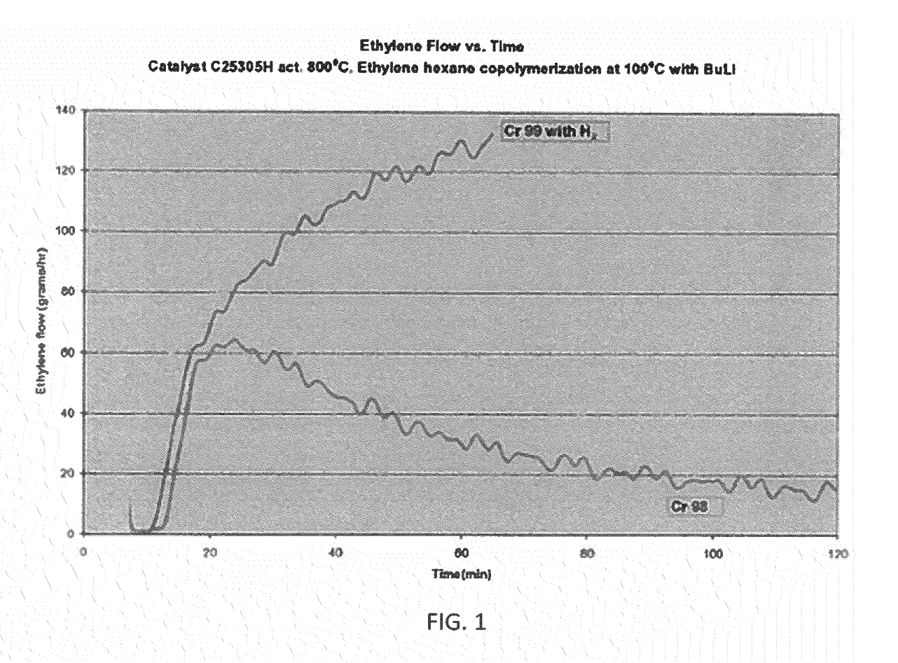

The Cr/silica catalyst mileage is improved with hydrogen by changing the polymerization kinetics. For example, FIG. 1 shows a plot of ethylene flow (g/Hr) versus time (minutes) during the polymerization of ethylene and hexane at 100° C. in the presence butyl lithium (BuLi) using a Cr/silica catalyst that was activated at 800° C. As shown in FIG. 1, in the absence of H₂ the catalyst exhibits initial activity then the activity progressively decays. This time activity curve shows the benefit of using hydrogen in the polymerization process.

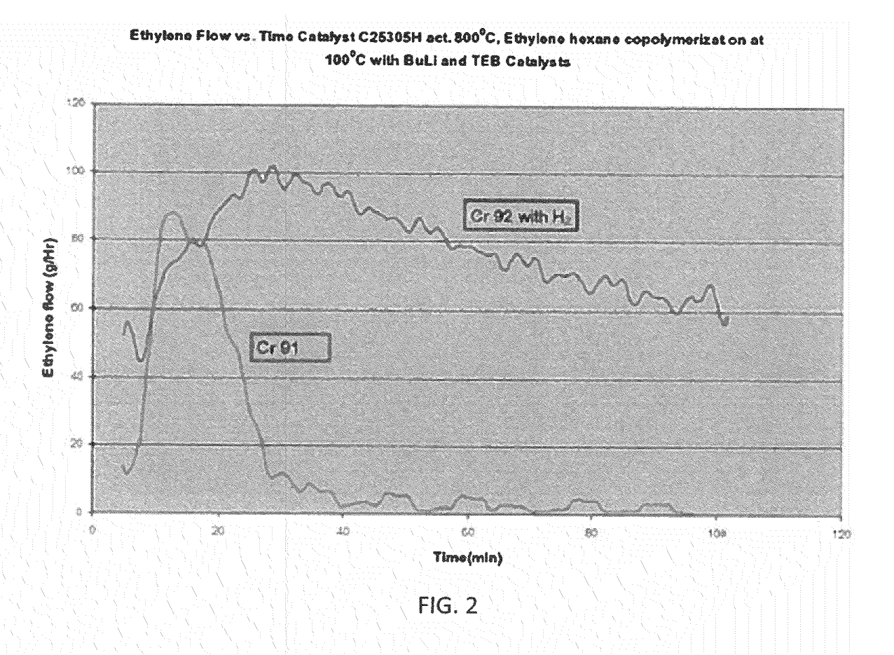

FIG. 2 shows a plot of ethylene flow (g/Hr) versus time (minutes) during the polymerization of ethylene and hexane at 100° C. in the presence of butyl lithium (BuLi) and TEB (co-catalyst) using a Cr/silica catalyst that was activated at 800° C. Not only does FIG. 2 show that in the absence of H₂ that the catalyst exhibits initial activity then decays, but when TEB is present the decay is quite severe and rapid. Both FIG. 1 and FIG. 2 show the benefits of using H₂ especially when using Cr/silica catalysts.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A process for polymerizing an olefin comprising the steps of:
(i) forming an activated silica supported chromium catalyst further comprising the steps of:
(a) preparing a homogeneous solution comprising an organic or inorganic chromium compound in a protic or aprotic polar solvent,
(b) bringing the resulting solution from (a) into contact with the silica material to form a solid,
(c) removing the solvent from the resulting solid formed in (b) thereby forming a chromium catalyst precursor; and
(d) calcination of the chromium catalyst precursor at a temperature between 350 to 1050° C., under oxidative conditions to form the activated silica supported chromium catalyst
(ii) polymerizing an olefin in the presence of
(a) the silica supported chromium catalyst
(b) a co-catalyst, and
(c) hydrogen wherein hydrogen is present in a concentration of 0.01 to 5 mole % based upon total content of polymerization contents.

2. A process according to claim 1 in which the cocatalyst is selected from organometallic compound of a metal from groups I to III of the Periodic Classification of the Elements.

3. A process according to claim 2, in which the co-catalyst is selected from the group consisting of organoaluminum compounds, lithium organo compounds, alkyl boron compounds and mixtures thereof.

4. The process according to claim 1, wherein the polymerization is carried out in gas phase or slurry phase.

5. The process according to claim 1, wherein the polymerization is carried out in the presence of hydrogen used in an amount of from 0.03 to 2 mole %.

6. The process according to claim 5 in which the amount of hydrogen ranges from 0.07 to 1.5 mole %.

7. The process according to claim 1 wherein, the supported chromium catalyst precursor is supported on a refractory oxide support.

8. The process according to claim 1 in which the supported chromium catalyst further comprises secondary dopants or mixtures of dopants.

9. The process according to claim 8 in which the dopants are organic or inorganic compounds of atoms selected from Mg, Ca, Sr, B, Al, Si, P. Bi, Sc, Ti, V. Mn, Fe, Co, Ni, Cu, Zn, Zr, Nb, Mo, Ru, Rh, Pd, Hf, Ta, W, B, and F.

10. The process according to claim 9 in which the dopant is selected from compounds of the general formula M(OR)ₙX₄₋ₙ, where M is titanium or zirconium and R is a hydrocarbon compound which has from 1 to 20 carbon atoms, and n is an integer from 0 to 4.
